(19) United States
(12) Patent Application Publication
(10) Pub. No.: US 2014/0258861 A1
(43) Pub. Date: Sep. 11, 2014

(54) CONTENT PRESENTATION WITH SECONDARY CONTENT SKIP

(71) Applicant: James A. Baldwin, Palo Alto, CA (US)

(72) Inventor: James A. Baldwin, Palo Alto, CA (US)

(21) Appl. No.: 13/790,176

(22) Filed: Mar. 8, 2013

(51) Int. Cl. G06F 3/0484

(52) U.S. Cl. CPC G06F 3/0484
USPC 715/716

(57) ABSTRACT

Apparatuses, methods and storage medium associated with content consumption are disclosed herein. In embodiments, an apparatus may include a decoder, a user interface engine, and a presentation engine. The decoder may be configured to receive and decode a streaming of the content. The stream of content may include a number of interleaved segments of primary content and secondary content, e.g., advertisements. The secondary content may have at least one associated policy that governs response to a skip secondary content command. The user interface engine may be configured to receive user commands. The presentation engine may be configured to present the content, in response to received user commands, in accordance with the at least one associated policy. Other embodiments may be described and/or claimed.

### TECHNICAL FIELD

The present disclosure relates to the field of data processing, in particular, to apparatuses, methods and storage medium associated with content presentation that includes support for skipping secondary content, such as, advertisements.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and the manners the contents are consumed. Today, multi-media contents may be available from fixed medium e.g., Versatile Disk (DVD)), broadcast, cable operators, satellite channels, Internet, and so forth. User may consume contents with a television set, a laptop or desktop computer, a tablet, a smartphone, or other stationary or mobile devices of the like. In addition to the contents themselves, ease of consumption remains an important factor to the overall user experience and satisfaction.

A significant conflict between content provider and content consumer, especially for deferred viewing, is viewing of commercials/advertisements, interleaved with segments of a program. Content provider often wants the content consumer to watch the commercials/advertisements, whereas the content consumer often wants to skip the commercials/advertisements, especially during deferred viewing. Currently, content consumer typically reties on “fast forward” to skip the commercials/advertisements. However, the user experience is not at all entirely satisfactory, as the user is often unable to stop the fast forward at precisely the start of the next segment of program. Frequently, the user will either stop too early or too late. When stopping the fast forward too early, the user will still watch a portion of the commercials/advertisements. When stopping the fast forward too late, the user will miss a portion of the beginning of the next program segment, unless the user back tracks the presentation. Often, the back track will be too far, resulting in multiple forward and backward before stopping at a point sufficient close to the beginning of the next segment of program.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for content distribution and consumption, in accordance with various embodiments.

FIG. 2 illustrates a content stream in further detail, in accordance with various embodiments.

FIG. 3 illustrates an example process for presenting content, in accordance with various embodiments.

FIG. 4 illustrates an example computing environment suitable for practicing the disclosure, in accordance with various embodiments.

FIG. 5 illustrates an example storage medium with instructions configured to enable an apparatus to practice the present disclosure, in accordance with various embodiments.

FIGS. 6 and 7 illustrate two example associated policies of secondary content, in accordance with various embodiments.

### DETAILED DESCRIPTION

Apparatuses, methods and storage medium associated with content distribution and/or consumption are disclosed herein. In embodiments, an apparatus, e.g., a set-top box, may include a decoder, a user interface engine, and a presentation engine. The decoder may be configured to receive and decode a streaming of a content, e.g., an audio/video program. The stream of content may include a number of interleaved segments of primary content and secondary content. The secondary content may have at least one associated policy that governs response to a user command to skip secondary content during presentation. An example of secondary content is advertisement. The user interface engine may be configured to receive user commands, including one or more user commands to skip secondary content during presentation. The presentation engine may be configured to present the content as the content is decoded and recovered from the stream, in response to received user commands, and in accordance with the at least one associated policy of the secondary content.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

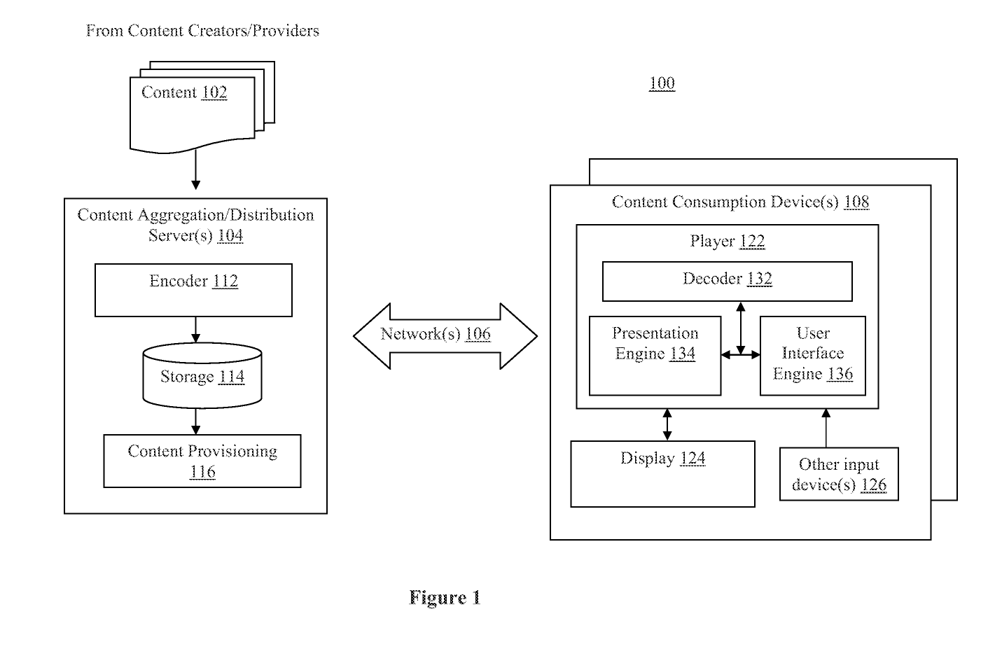

Referring now FIG. 1, wherein an arrangement for content distribution and consumption, in accordance with various embodiments, is illustrated. As shown, in embodiments, arrangement 100 for distribution and consumption of content may include a number of content consumption devices 108 coupled with one or more content aggregation/distribution servers 104 via one or more networks 106. Content aggregation/distribution servers 104 may be configured to aggregate and distribute contents to content consumption devices 108 for consumption, via one or more networks 106. As will be described in more detail below, content aggregation/distribution servers 104 and/or content consumption devices 108 may be incorporated with various teachings of the present disclosure to provide users of content consumption devices 108 with potentially enhanced user experience.

In embodiments, as shown, content aggregation/distribution servers 104 may include encoder 112, storage 114 and content provisioning 116, coupled to each other as shown. Encoder 112 may be configured to encode contents 102 from various content providers, and storage 114 may be configured to store encoded content. Content provisioning 116 may be configured to selectively retrieve and stream encoded content to the various content consumption devices 108 in response to requests from the various content consumption devices 108.

Contents 102 may be multi-media contents of various types, having video, audio, and/or closed captions, from a variety of content creators and/or providers. Examples of contents may include, but are not limited to, movies, TV programming, user created contents (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In embodiments, for efficiency of operation, encoder 112 may be configured to transcode the various contents 102, typically in different encoding formats, into a subset of one or more common encoding formats. However, encoder 112 may be configured to nonetheless maintain indices or cross-references to the corresponding contents in their original encoding formats. Similarly, for flexibility of operation, encoder 112 may transcode or otherwise process each or selected ones of contents 102 into multiple versions of different quality levels. The different versions may provide different resolutions, and/or require different bit rates and/or frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video and/or audio data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provisioning 116 may, in various embodiments, be configured to provide encoded content as discrete files and/or as continuous streams of encoded content. Content provisioning 116 may be configured to transmit the compressed audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

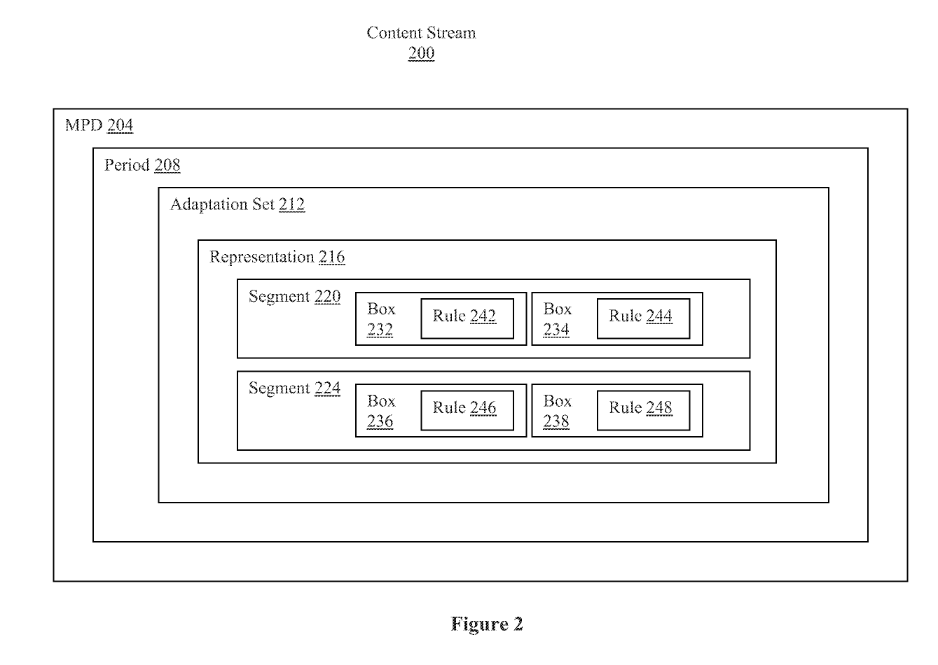

Referring now also to FIG. 2, wherein an example content stream, in accordance with various embodiments, is illustrated. As described earlier, content 102 may be encoded by encoder 112 into different versions having different bit rates, channels, sizes, or some other parameter which may generally or collectively referred to as a QoS parameter defining a QoS level. Each version of the encoded content stream 200 may be divided into discrete segments which can then be selectively requested by the content consumption device 108. For example, the content consumption device 108 may send a request via hypertext transfer protocol (HTTP) or some other internet protocol to a server such as a content aggregation/distribution server 104. The content aggregation/distribution server 104 may respond by providing the requested segment.

A potential benefit of the content 102 being encoded into different versions according to multiple different QoS parameters and QoS levels may be realized when content consumption device 108 detects that a tower QoS level is necessary, or a higher QoS level is permissible, then the content consumption device 108 may simply request a segment at a different QoS level. Similarly, the content consumption device 108 may request different segments if a viewer of the content 102 requests additional features such as different audio streams, close captioning, or the like. The content aggregation/distribution server 104 may respond by supplying the segment at the different QoS level, rather than having to supply and re-buffer the entire content 102. This allows the viewing of the content 102 to take place in a more dynamic fashion without lengthy buffering or re-buffering periods.

In embodiments, the encoded content stream 200 may include a media presentation description (MPD) 204 document. The MPD 204 may describe a sequence of periods 208 that represent a content period during which a consistent set of encoded versions of the content is available. In other words, the set of available bitrates, languages, captions, subtitles, or other QoS parameters or QoS levels may remain unchanged during the period 208. Although only a single period 208 is depicted in FIG. 2, other embodiments may have an MPD 204 with multiple periods, each having different available bitrates, languages, captions, subtitles, or other QoS parameters or QoS levels. In embodiments, the captions may be in multiple languages.

Within a period 208, the content may be arranged into adaptation sets 212. The adaptation set 212 may represent a set of interchangeable encoded versions of one or several content components such as a video component, an audio component, etc. Other components such as captions or audio descriptions may likewise have a separate adaptation set 212. Although only a single adaptation set 212 is shown in FIG. 2, in other embodiments each period 208 may comprise a plurality of adaptation sets 212.

Each adaptation set 212 may comprise one or more representations 216. A representation may describe the deliverable encoded versions of one or several content components of the content 102 or secondary content, such as commercials/advertisements, interleaved in between segments of the primary content. For example, a representation 216 may include one or more streams for each content component such as audio components, video components, captions, or audio descriptions of the primary or secondary content. In general, any single representation 216 within an adaptation set 212 may be sufficient to render the contained content components. In embodiments, each adaptation set 212 may include a plurality of representations 216.

Each representation 216 may be divided into one or more segments 220 and 224. In general, a segment 220 and 224 may be considered to be the largest unit of the encoded content 200 that may be retrieved by a single HTTP request. In embodiments, the segment 220 may have a different length or duration than segment 224. In some embodiments, the segment length may vary between representations such that the length of segment 220 and 224 in representation 216 may be on the order of a few seconds, while in another representation the length of a segment may be as long as the length of the representation or some value in between.

In embodiments, each segment such as segment 220 or segment 224 may be encoded according to an ISO base media file format such as that defined in ISO/IEC 14496-12:2012. Specifically, each segment such as segment 220 or segment 224 may comprise a plurality of boxes 232 and 234 or 236 and 238 respectively. In some embodiments the boxes 232-238, may comprise one or more presentation rules 242-248, that governs the presentation of one or more segments. In embodiments, some of the one or more presentation rules 242-248 maybe associated with the corresponding secondary content, and governs presentation of the secondary content, e.g., skipping of the secondary content, in response to a user command to skip secondary content during presentation. The rules may also be referred as policies. In embodiments, the rules or policies may be provided to the content consumption devices separately (as opposed to integrally), via e.g., a manifest, separate from the content stream. In either case, decoder 132, or some other component, may be configured to receive the policies separately or extract the policies from the content stream, and process them for use by presentation engine 134. Typically, associated policies integrally provided with the content stream may govern only skipping of secondary content of the content stream. On the other hand, associated policies separately provided, e.g., in advance, may govern skipping of secondary content of multiple content streams.

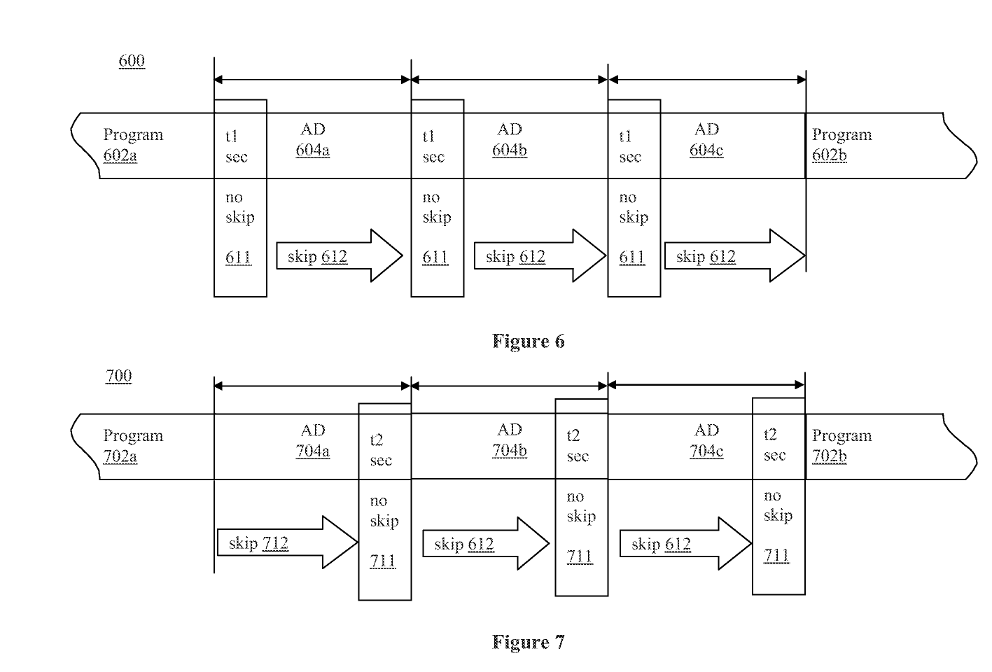

Referring now briefly to FIGS. 6 and 7, wherein two example associated policies of secondary content are illustrated, in accordance with various embodiments. In the example of FIG. 6, policy 600, may specify that at least t1 seconds, e.g., 5, of the beginning 611 of each secondary content, e.g., advertisements 604a-604c, between two primary content segments, e.g., program segments 602a and 602b, must be played, before the remainders of the corresponding secondary content may be skipped. In the example of FIG. 7, policy 700, may specify that most of each secondary content, e.g., advertisements 704a-704c, between two primary content segments, e.g., program segments 702a and 702b, may be skipped, however, at least the last t2 seconds, e,g. 5, at the end 711, of each secondary content must be played.

In other embodiments, another example of the associated policies may include a policy that specifies a limiting number of secondary content (max) to be fully or partially skipped within a time interval or during a content consumption session. Still another example of the associated policies may include a policy that specifies at least n secondary content in between two primary content segments must be played in part or in full. Yet another example of the associated policies may include a policy that specifies not playing a secondary content in full or in part, if the secondary content was last played less than t units of time earlier. Above are illustrative and not limiting examples. Many other policies may be practiced with the present disclosure.

Referring back to FIG. 1, thus, in embodiments, player 122, e.g., presentation engine 134, may be configured, e.g., including data structures and logic, to track when each secondary content was last fully or partially played, and the number of secondary contents fully or partially skipped or played for a time interval or during a content consumption session.

Continuing to refer to FIG. 1, networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which servers 104 go through to communicate with content consumption devices 108. Similarly, at the content consumption end, networks 106 may include base stations and/or access points, through which consumption devices 108 communicate with servers 104. In between the two ends may be any number of network routers, switches and other networking equipment of the like. However, for ease of understanding, these gateways, firewalls, routers, switches, base stations, access points and the like are not shown.

In embodiments, as shown, a content consumption device 108 may include player 122, display 124 and user input device 126. Player 122 may be configured to receive streamed content, decode and recovered the content from the content stream, and present the recovered content on display 124, in response to user selections/inputs from user input device 126 Further, player 122 may be configured to adapt the presentation of a content to enhance user experience during response to some user commands, where the adaptation is in addition to a nominal response to the user commands. In embodiments, player 122 may be configured to adapt the presentation of a content to enhance user experience, including support for responding to a user command to skip secondary content during presentation. The responsive skipping may be in accordance with the associated policies, such as the illustrative policies described earlier and other policies of the like. In embodiments, player 122 may be configured to ignore a skip secondary content command, and not skip presentation of the secondary content, if no policy governing skipping presentation of secondary content has been received/extracted and processed, at the time the skip secondary content command is received.

In embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. User interface engine 136 may be configured to receive the user selections/inputs from a user.

Further, in various embodiments, decoder 132, presentation engine 136, and user interface engine 136, combinations or sub-combinations thereof, may be configured to effectuate for player 122 the earlier described adaptation of the presentation of a content to enhance user experience during response to some user commands, where the adaptation is in addition to a nominal response to the user commands. See e.g. U.S. patent application Ser. No. 13/727,138, entitled “CONTENT PRESENTATION WITH ENHANCED USER EXPERIENCE,” filed Dec. 26, 2012, for further details. Similarly, decoder 132, presentation engine 134, and user interface engine 136, combinations or sub-combinations thereof, may also be configured to effectuate for player 122 the earlier described partial response to one or more other user commands in view of one or more rules associated with presentation of the content to enhance user experience. In embodiments, decoder 132 may be configured to receive and process the associated policies governing skipping of secondary content, separate from the receipt and decoding of the stream of content. In other embodiments, decoder 132 may be configured to extract the associated policies from the stream of content. Presentation engine 134 may be configured with all or the bulk of logic for responding to a skip secondary content command, in accordance with the associated policies. User interface engine 136 may be configured to receive and forward the skip secondary content commands.

While shown as part of a content consumption device 108, display 124 and/or user input device(s) 126 may be standalone devices or integrated, for different embodiments of content consumption devices 108. For example, for a television arrangement, display 124 may be a stand-alone television set, Liquid Crystal Display (LCD), Plasma and the like, while player 122 may be part of a separate set-top set, and other user input device 126 may be a separate remote control or keyboard. Similarly, for a desktop computer arrangement, player 122, display 124 and other input device(s) 126 may all be separate stand atone units. On the other hand, for a laptop, ultrabook, tablet or smartphone arrangement, player 122, display 124 and other input devices 126 may be integrated together into a single form factor. Further, for tablet or smartphone arrangement, a touch sensitive display screen may also server as one of the other user input device(s) 126, and player 122 may be a computing platform with a soft keyboard that also include one of the user input device(s) 126.

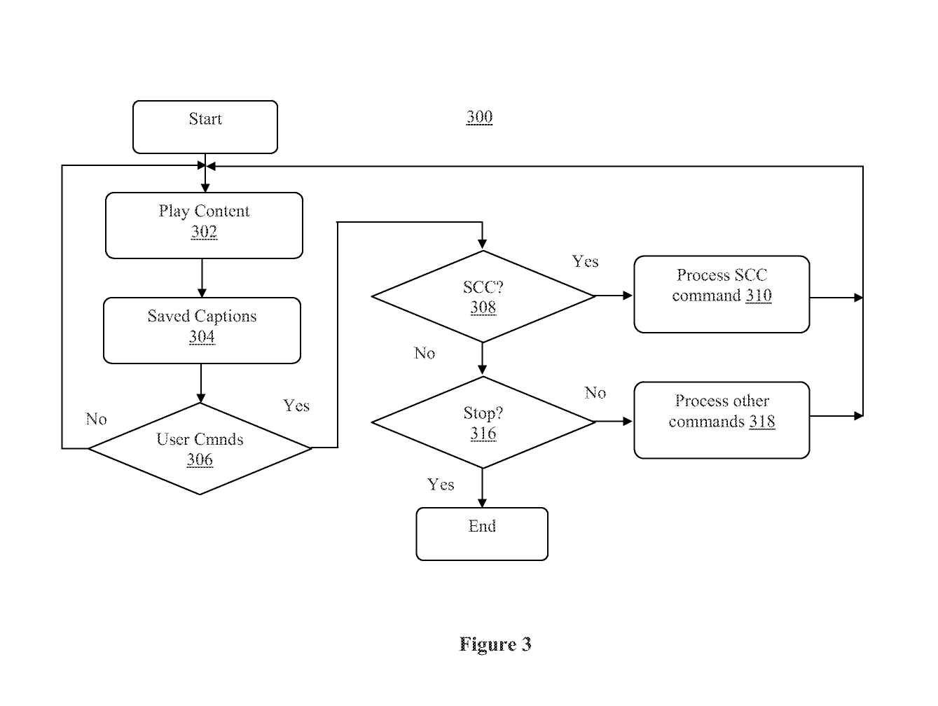

Referring now to FIG. 3, wherein an example process for presenting content, in accordance with various embodiments, is illustrated. As shown, process 300 may start at block 302, where content may be played. As described earlier, content playing may include presentation of content recovered from a received content stream, e.g., by presentation engine 134, onto a display device, e.g., display 124. From block 302, the process may proceed to block 304. In block 304, a configurable amount of the closed captions associated with the content being played may be continuously cached. The closed captions may be cached regardless whether the recovered content is being played with or without closed caption enabled. For these embodiments, the closed captions would be even more readily available when they are needed.

From block 304, process 300 may proceed to block 306. At block 306, process 300 may determine, e.g., by user interface engine 136, whether a user command has been received. If a result of the determination at block 306 indicates that no user command has been received, process 300 may return to block 302, and continue from there as earlier described. On the other hand, if a result of the determination at block 306 indicates a user command has been received, process 300 may proceed to block 308.

At block 308, process 300 may determine, e.g., by user interface engine 136, whether the received user command is the skip secondary content (SCC) command. If a result of the determination at block 308 indicates that the received user command is the SCC command, process 300 may proceed to block 310.

At block 310, process 300 may first determine whether any policy governing the skipping of secondary content during presentation has been received/extracted and processed. In embodiments, if a result of the determination indicates that no policy governing the skipping of secondary content during presentation has been received/extracted and processed, process 300, e.g. presentation engine 134, may effectively ignore the skip secondary content command, and not skip any of the secondary content being presented. For example, presentation engine 134 may merely respond with an information message indicating skipping of secondary content is not permitted. Process 300 may immediately transition from block 310 to block 302 and from there, continue as earlier described.

On the hand, if a result of the determination indicates that at least one associated policy governing the skipping of secondary content has been received/extracted and processed, process 300, e.g. presentation engine 134, may skip the secondary content in accordance with those associated policies. For example, as described earlier, play only the beginning or the ending t seconds of each secondary content, so skipping as tong as the number of secondary content (partially or fully) skipped does not exceed a limiting number of secondary content that can be skipped within a time interval or content consumption session, or skip a secondary content if it has been recently played in full or in part less than t units of time earlier, and so forth. In embodiments, where a policy specifies a limiting number of secondary content to be skipped in a time interval or content consumption session, player 122, e.g., presentation engine 134 may further track the number of secondary content skipped within the specified running time interval or content consumption session, and reset the tracked number of skips on expiration of each specified time interval or end of a content consumption session. In embodiments, where a policy specifies skipping of a secondary content if it has been last played in part or in full less than t units of time earlier, player 122, e.g., presentation engine 134 may further track the time when each secondary content was last played. After the secondary content has been skipped in accordance with the associated policies, process 300 may transition from block 310 to block 302 and from there, continue as earlier described.

In embodiments, if a result of the determination indicates that no associated policy has been received/extracted and processed, process 300 may nonetheless respond to the skip secondary content command fully or partially in accordance with a defaulted policy. The default policy may be one of the earlier described example policies or combination thereof.

Referring again to block 308, if a result of the determination indicates that the received user command is not an SCC command, process 300 may proceed to block 316. At block 316, process 300 may determine whether the received user command is a stop command. If a result of the determination at block 316 indicates that the received user command is not a stop command, process 300 may proceed to block 318, where the command may be processed accordingly. From block 318, process 300 may return to block 302 and from there, continue as earlier described.

On the other hand, if a result of the determination at block 316 indicates that the received command is a stop command, process 300 may end.

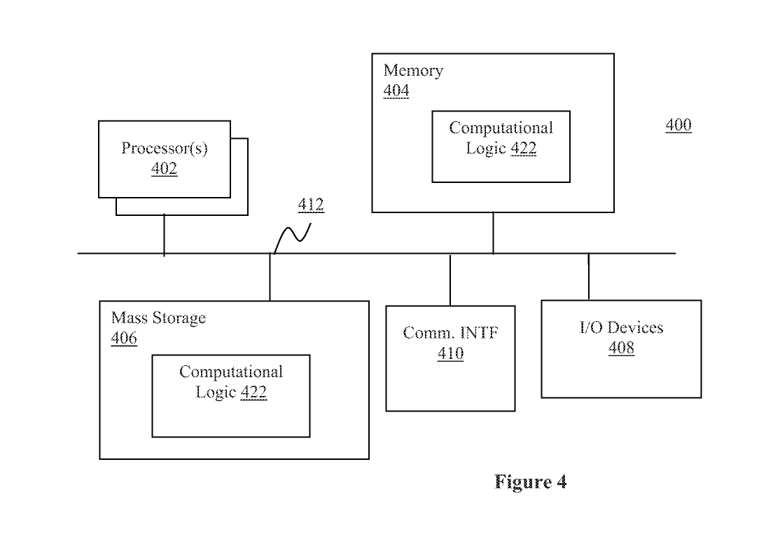

Referring now to FIG. 4, wherein an example computer suitable for use for the arrangement of FIG. 1, in accordance with various embodiments, is illustrated. As shown, computer 400 may include one or more processors or processor cores 402, and system memory 404. For the purpose of this application, including the claims, the terms “processor” and “processor cores” may be considered synonymous, unless the context clearly requires otherwise. Additionally, computer 400 may include mass storage devices 406 (such as diskette, hard drive, compact disc read only memory (CD-ROM) and so forth), input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage devices 406 may be employed to store a working copy and a permanent copy of the programming instructions implementing the operations associated with content aggregation/distribution servers 104 or content consumption devices 108, earlier described. The various elements may be implemented by assembler instructions supported by processor(s) 402 or high-level languages, such as, for example, C, that can be compiled into such instructions.

The permanent copy of the programming instructions may be placed into permanent storage devices 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The number, capability and/or capacity of these elements 410-412 may vary, depending on whether computer 400 is used as a content aggregation/distribution server 104 or a content consumption device 108. When use as content consumption device, whether the content consumption device is a stationary or mobile device, like a smartphone, computing tablet, ultrabook or laptop. Their constitutions are otherwise known, and accordingly will not be further described.

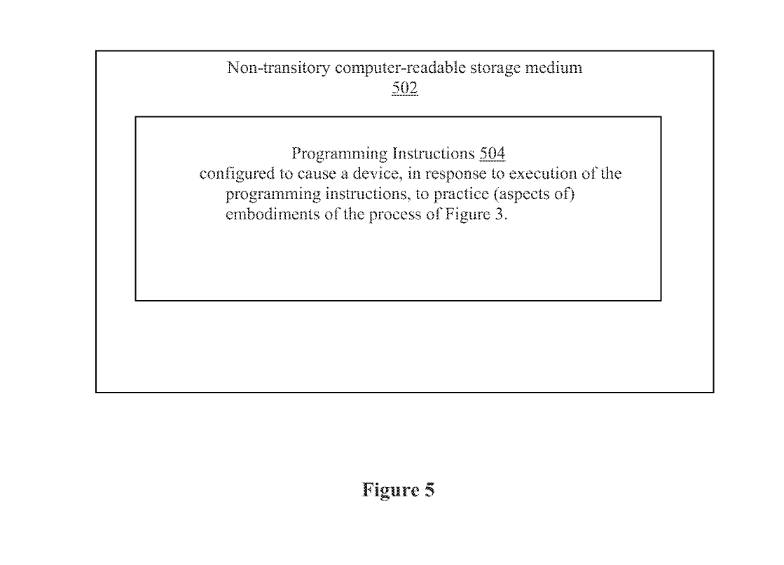

FIG. 5 illustrates an example non-transitory computer-readable storage medium having instructions configured to practice all or selected ones of the operations associated with content aggregation/distribution servers 104 or content consumption devices 108, earlier described; in accordance with various embodiments. As illustrated, non-transitory computer-readable storage medium 502 may include a number of programming instructions 504. Programming instructions 504 may be configured to enable a device, e.g., computer 400, in response to execution of the programming instructions, to perform, e.g., various operations of process 300 of FIG. 3, but not limited to, the operations performed in association with responding to a skip secondary content command during presentation in accordance with associated policies of the secondary content. In alternate embodiments, programming instructions 504 may be disposed on multiple non-transitory computer-readable storage media 502 instead.

Referring back to FIG. 4, for one embodiment, at leas one of processors 402 may be packaged together with computational logic 422 (in lieu of storing on memory 404 and storage 406) configured to practice aspects of the process of FIG. 3. For one embodiment, at least one of processors 402 may be packaged together with computational logic 422 configured to practice aspects of the process of FIG. 3 to form a System in Package (SiP). For one embodiment, at least one of processors 402 may be integrated on the same die with computational logic 422 configured to practice aspects of the process of FIG. 3. For one embodiment, at least one of processors 402 may be packaged together with computational logic 422 configured to practice aspects of the process of FIG. 3 to form a System on Chip (SoC). For at least one embodiment, the SoC may be utilized in, e.g., but not limited to, a computing tablet.

Thus various example embodiments of the present disclosure have been described including, but are not limited to:

Example 1, which may be an apparatus for consuming content. The apparatus may include a decoder configured to receive and decode a streaming of the content, wherein the stream of content includes a plurality of interleaved segments of primary content sand secondary content, and wherein the secondary content has at least one associated policy that governs response to a user command to skip the secondary content during presentation; and a user interface engine configured to receive user commands including one or more commands to skip the secondary content during presentation. The apparatus may further include a presentation engine coupled to the decoder and the user interface engine, and configured to cooperate with the decoder and the user interface engine, to present the content as the content is decoded from the stream, in response to received user commands, wherein presentation of the secondary content in response to a user command to skip the secondary content is in accordance with the at least one associated policy.

Example 2 which includes the subject matter of example 1, and wherein the stream of content and the at least one associated policy are separately provided to the apparatus, and the decoder is further configured to separately receive and process the at least one associated policy that governs response to a user command to skip the secondary content during presentation.

Example 3 which includes the subject matter of example 1, and wherein the stream of content and the at least one associated policy are integrally provided to the apparatus, and the decoder is further configured to extract and process the at least one associated policy that governs response to a user command to skip the secondary content during presentation,

Example 4 which includes the subject matter of example 1, and wherein the presentation engine is configured to determine whether at least one associated policy that governs response to a user command to skip the secondary content during presentation has been received or extracted, and processed, after receipt of a user command to skip the secondary content during presentation.

Example 5 which includes the subject matter of example 4, and wherein the presentation engine is configured to not skip presentation of secondary content, if a result of the determination indicates that no associated policy that governs response to a user command to skip the secondary content during presentation has been received or extracted, and processed.

Example 6 which includes the subject matter of any one of example 1-5, and wherein the at least one associated policy comprises a policy of presenting at least t seconds of each second content disposed in between two segments of primary content, wherein the presentation engine is configured to respond to a user command to skip the secondary content during presentation with not playing an entirety of each second content disposed in between two segments of primary content, but playing at least t seconds.

Example 7 which includes the subject matter of example 6, and wherein the at least t seconds comprises at least t starting seconds of each secondary content.

Example 8 which includes the subject matter of example 6, and wherein the at least t seconds comprises at least t ending seconds of each secondary content.

Example 9 which includes the subject matter of any one of examples 1-5, and wherein the at least one associated policy comprises a policy of partially or fully play at least n secondary contents of each group of secondary content disposed between two segments of primary content before skipping to a beginning of the next segment of primary content; wherein the presentation engine is configured to respond to a user command to skip the secondary content during presentation, partially or fully play at least n secondary contents of each group of secondary content disposed between two segments of primary content, then skip to a beginning of the next segment of primary content.

Example 10 which includes the subject matter of example 9, and wherein the presentation engine is configured to track a number of secondary content at least partially skipped.

Example 11 which includes the subject matter of any one of examples 1-5, and wherein the at least one associated policy comprises a policy of limiting a number of secondary content fully or partially skips, wherein the presentation engine is configured to respond to a user command to skip the secondary content during presentation with not playing an entirety or partially of a second content only while the limiting number of secondary content that can be entirely or partially skipped has not been reached.

Example 12 which includes the subject matter of any one of examples 1-5, and wherein the policy of limiting a number of secondary content fully or partially skips comprises a policy of limiting a number of secondary content fully or partially skips for a time interval or for a content consumption session, wherein the presentation engine is configured to respond to a user command to skip the secondary content during presentation with not playing an entirety or partially of a second content only while the limiting number of secondary content that can be entirely or partially skipped has not been reached for the time interval or content consumption session.

Example 13 which includes the subject matter of example 12, wherein the presentation engine is configured to track a number of secondary content at least partially skipped during the time interval or content consumption session.

Example 14 which includes the subject matter of any one of examples 1-5, wherein the at least one associated policy comprises a policy of skipping any secondary content that has been last presented less than a time interval; wherein the presentation engine is configured to respond to a user command to skip secondary content during presentation, skipping any secondary content that has been last presented within the time interval.

Example 15 which includes the subject matter of example 14, wherein the presentation engine is configured to track when a secondary content was last presented.

Example 16 which includes the subject matter of any one of examples 1-5, wherein the apparatus is a selected one of set-top box, a television, a desktop computer, a laptop computer, an ultrabook, a computing tablet, or a smartphone.

Example 17 includes at east one storage medium comprising a plurality of instructions configured to cause a content consumption device, in response to execution of the instructions by the content consumption device, to decode a streaming of the content, wherein the stream of content includes a plurality of interleaved segments of primary content and secondary content, and wherein the secondary content has at least one associated policy that governs response to a user command to skip secondary content during presentation; and receive user commands, including one or more commands to skip secondary content during presentation. The content consumption device may also be caused to present the content as the content is decoded from the stream, in response to received user commands, wherein presentation of the secondary content in response to a user command to skip secondary content during presentation is in accordance with the at least one associated policy.

Example 18 includes the subject matter of example 17, and wherein the stream of content and the at least one associated policy are separately provided to the apparatus, and wherein the instructions, in response to execution of the instructions by the content consumption device, cause the content consumption device to separately receive and process the at least one associated policy that governs response to a user command to skip the secondary content during presentation.

Example 19 includes the subject matter of example 17, and wherein the stream of content and the at least one associated policy are integrally provided to the apparatus, and wherein the instructions, in response to execution of the instructions by the content consumption device, cause the content consumption device to extract and process the at least one associated policy that governs response to a user command to skip the secondary content during presentation.

Example 20 includes the subject matter of example 17, wherein the stream of content and the at least one associated policy are separately provided to the apparatus, and wherein the instructions, in response to execution of the instructions by the content consumption device, cause the content consumption device to determine whether at least one associated policy that governs response to a user command to skip the secondary content during presentation has been received or extracted, and processed, after receipt of a user command to skip the secondary content during presentation.

Example 21 includes the subject matter of any one of examples 17-20, and wherein the at least one associated policy comprises a policy of presenting at least t seconds of each second content disposed in between two segments of primary content, wherein the instructions, in response to execution of the instructions by the content consumption device, cause the content consumption device to respond to a user command to skip the secondary content during presentation with not playing an entirety of each second content disposed in between two segments of primary content, but playing at least t seconds.

Example 22 includes the subject matter of any one of examples 17-20, and wherein the at least one associated policy comprises a policy of partially or fully play at least n secondary contents of each group of secondary content disposed between two segments of primary content before skipping to a beginning of the next segment of primary content; wherein the instructions, in response to execution of the instructions by the content consumption device, cause the content consumption device to respond to a user command to skip the secondary content during presentation, partially or fully play at least n secondary contents of each group of secondary content disposed between two segments of primary content, then skip to a beginning of the next segment of primary content.

Example 23 includes the subject matter of any one of examples 17-20, and wherein the at least one associated policy comprises a policy of limiting a number of secondary content fully or partially skips, wherein the instructions, in response to execution of the instructions by the content consumption device, cause the content consumption device to respond to a user command to skip the secondary content during presentation with not playing an entirety or partially of a second content only while the limiting number of secondary content that can be entirely or partially skipped has not been reached.

Example 24 includes the subject matter of any one of examples 17-20, and wherein the at least one associated policy comprises a policy of skipping any secondary content that has been last presented less than a time interval; wherein the instructions, in response to execution of the instructions by the content consumption device, cause the content consumption device to respond to a user command to skip secondary content during presentation, skipping any secondary content that has been last presented within the time interval.

Example 25 is a method for consuming method. The method may include decoding, with a decoder, a streaming of the content, wherein the stream of content includes a plurality of interleaved segments of primary content sand secondary content, and wherein the secondary content has at least one associated policy that governs response to a user command to skip secondary content during presentation; and receiving, with a user interface engine, user commands, including one or more commands to skip secondary content during presentation. The method may further include presenting the content as the content is decoded from the stream, with a presentation engine, in response to received user commands, wherein presentation of the secondary content in response to a user command to skip secondary content during presentation is in accordance with the at least one associated policy.

Example 26 may include the subject matter of example 25, and wherein the at least one associated policy comprises a policy of presenting at least t seconds of each second content disposed in between two segments of primary content, wherein the method further comprises responding to a user command to skip the secondary content during presentation with not playing an entirety of each second content disposed in between two segments of primary content, but playing at least t seconds,

Example 27 may include the subject matter of example 25, and wherein the at least one associated policy comprises a policy of partially or fully play at least n secondary contents of each group of secondary content disposed between two segments of primary content before skipping to a beginning of the next segment of primary content; wherein the method further comprises responding to a user command to skip the secondary content during presentation, partially or fully playing at least n secondary contents of each group of secondary content disposed between two segments of primary content, then skipping to a beginning of the next segment of primary content.

Example 28 may include the subject matter of example 25, and wherein the at least one associated policy comprises a policy of limiting a number of secondary content fully or partially skips, wherein the method further comprises responding to a user command to skip the secondary content during presentation with not playing an entirety or partially of a second content only while the limiting number of secondary content that can be entirely or partially skipped has not been reached.

Example 29 may include the subject matter of example 25, and wherein the at least one associated policy comprises a policy of skipping any secondary content that has been last presented less than a time interval; wherein the method further comprises responding to a user command to skip secondary content during presentation, skipping any secondary content that has been last presented within the time interval.

Example 30 may be an apparatus for consuming content. The apparatus may include means for receiving and decoding a streaming of the content, wherein the stream of content includes a plurality of interleaved segments of primary content sand secondary content, and wherein the secondary content has at least one associated policy that governs response to a user command to skip the secondary content during presentation; and means for receiving user commands including one or more commands to skip the secondary content during presentation. The apparatus may further includes means for presenting the content as the content is decoded from the stream, in response to received user commands, wherein presentation of the secondary content in response to a user command to skip the secondary content is in accordance with the at least one associated policy.

Example 31 includes the subject matter of example 30, and wherein the stream of content and the at least one associated policy are separately provided to the apparatus, and the decoding means comprises means for separately receiving and processing the at least one associated policy that governs response to a user command to skip the secondary content during presentation.

Example 32 includes the subject matter of example 30, and wherein the stream of content and the at least one associated policy are integrally provided to the apparatus, and the decoding means comprises means for extracting and processing the at least one associated policy that governs response to a user command to skip the secondary content during presentation.

Example 33 includes the subject matter of example 30, and wherein the presenting means comprises means for determining whether at least one associated policy that governs response to a user command to skip the secondary content during presentation has been received or extracted, and processed, after receipt of a user command to skip the secondary content during presentation.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for consuming content, comprising:
a decoder configured to receive and decode a streaming of the content, wherein the stream of content includes a plurality of interleaved segments of primary content sand secondary content, and wherein the secondary content has at least one associated policy that governs response to a user command to skip the secondary content during presentation;
a user interface engine configured to receive user commands including one or more commands to skip the secondary content during presentation; and
a presentation engine coupled to the decoder and the user interface engine, and configured to cooperate with the decoder and the user interface engine, to present the content as the content is decoded from the stream, in response to received user commands, wherein presentation of the secondary content in response to a user command to skip the secondary content is in accordance with the at least one associated policy.

2. The apparatus of claim 1, wherein the stream of content and the at least one associated policy are separately provided to the apparatus, and the decoder is further configured to separately receive and process the at least one associated policy that governs response to a user command to skip the secondary content during presentation.

3. The apparatus of claim 1, wherein the stream of content and the at least one associated policy are integrally provided to the apparatus, and the decoder is further configured to extract and process the at least one associated policy that governs response to a user command to skip the secondary content during presentation.

4. The apparatus of claim 1, wherein the presentation engine is configured to determine whether at least one associated policy that governs response to a user command to skip the secondary content during presentation has been received or extracted, and processed, after receipt of a user command to skip the secondary content during presentation.

5. The apparatus of claim 4, wherein the presentation engine is configured to not skip presentation of secondary content, if a result of the determination indicates that no associated policy that governs response to a user command to skip the secondary content during presentation has been received or extracted, and processed.

6. The apparatus of claim 1, wherein the at least one associated policy comprises a policy of presenting at least t seconds of each second content disposed in between two segments of primary content, wherein the presentation engine is configured to respond to a user command to skip the secondary content during presentation with not playing an entirety of each second content disposed in between two segments of primary content, but playing at least t seconds.

7. The apparatus of claim 6, wherein the at least t seconds comprises at least t starting seconds of each secondary content, or at least t ending seconds of each secondary content.

8. The apparatus of claim 1, wherein the at least one associated policy comprises a policy of partially or fully play at least n secondary contents of each group of secondary content disposed between two segments of primary content before skipping to a beginning of the next segment of primary content; wherein the presentation engine is configured to respond to a user command to skip the secondary content during presentation, partially or fully play at least n secondary contents of each group of secondary content disposed between two segments of primary content, then skip to a beginning of the next segment of primary content,

9. The apparatus of claim 8, wherein the presentation engine is configured to track a number of secondary content at least partially skipped.

10. The apparatus of claim 1, wherein the at least one associated policy comprises a policy of limiting a number of secondary content fully or partially skips, wherein the presentation engine is configured to respond to a user command to skip the secondary content during presentation with not playing an entirety or partially of a second content only while the limiting number of secondary content that can be entirely or partially skipped has not been reached.

11. The apparatus of claim 10, wherein the policy of limiting a number of secondary content fully or partially skips comprises a policy of limiting a number of secondary content fully or partially skips for a time interval or for a content consumption session, wherein the presentation engine is configured to respond to a user command to skip the secondary content during presentation with not playing an entirety or partially of a second content only while the limiting number of secondary content that can be entirely or partially skipped has not been reached for the time interval or content consumption session.

12. The apparatus of claim 11, wherein the presentation engine is configured to track a number of secondary content at least partially skipped during the time interval or content consumption session.

13. The apparatus of claim 1, wherein the at least one associated policy comprises a policy of skipping any secondary content that has been last presented less than a time interval; wherein the presentation engine is configured to respond to a user command to skip secondary content during presentation, skipping any secondary content that has been last presented within the time interval.

14. The apparatus of claim 13, wherein the presentation engine is configured to track when a secondary content was last presented.

15. At least one storage medium comprising a plurality of instructions configured to cause a content consumption device, in response to execution of the instructions by the content consumption device, to:
decode a streaming of the content, wherein the stream of content includes a plurality of interleaved segments of primary content sand secondary content, and wherein the secondary content has at least one associated policy that governs response to a user command to skip secondary content during presentation;
receive user commands, including one or more commands to skip secondary content during presentation; and
present the content as the content is decoded from the stream, in response to received user commands, wherein presentation of the secondary content in response to a user command to skip secondary content during presentation is in accordance with the at least one associated policy.

16. The at least one storage medium of claim 15, wherein the stream of content and the at least one associated policy are separately provided to the apparatus, and wherein the instructions, in response to execution of the instructions by the content consumption device, cause the content consumption device to separately receive and process the at least one associated policy that governs response to a user command to skip the secondary content during presentation.

17. The at least one storage medium of claim 15, wherein the stream of content and the at least one associated policy are integrally provided to the apparatus, and wherein the instructions, in response to execution of the instructions by the content consumption device, cause the content consumption device to extract and process the at least one associated policy that governs response to a user command to skip the secondary content during presentation.

18. The at least one storage medium of claim 15, wherein the stream of content and the at least one associated policy are separately provided to the apparatus, and wherein the instructions, in response to execution of the instructions by the content consumption device, cause the content consumption device to determine whether at least one associated policy that governs response to a user command to skip the secondary content during presentation has been received or extracted, and processed, after receipt of a user command to skip the secondary content during presentation.

19. The at least one storage medium of claim 15, wherein the at least one associated policy comprises a policy of presenting at least t seconds of each second content disposed in between two segments of primary content, wherein the instructions, in response to execution of the instructions by the content consumption device, cause the content consumption device to respond to a user command to skip the secondary content during presentation with not playing an entirety of each second content disposed in between two segments of primary content, but playing at least t seconds.

20. The at least one storage medium of claim 15, wherein the at least one associated policy comprises a policy of partially or fully play at least n secondary contents of each group of secondary content disposed between two segments of primary content before skipping to a beginning of the next segment of primary content; wherein the instructions, in response to execution of the instructions by the content consumption device, cause the content consumption device to respond to a user command to skip the secondary content during presentation, partially or fully play at least n secondary contents of each group of secondary content disposed between two segments of primary content, then skip to a beginning of the next segment of primary content.

21. The at least one storage medium of claim 15, wherein the at least one associated policy comprises a policy of limiting a number of secondary content fully or partially skips, wherein the instructions, in response to execution of the instructions by the content consumption device, cause the content consumption device to respond to a user command to skip the secondary content during presentation with not playing an entirety or partially of a second content only while the limiting number of secondary content that can be entirely or partially skipped has not been reached.

22. The at least one storage medium of claim 15, wherein the at least one associated policy comprises a policy of skipping any secondary content that has been last presented less than a time interval; wherein the instructions, in response to execution of the instructions by the content consumption device, cause the content consumption device to respond to a user command to skip secondary content during presentation, skipping any secondary content that has been last presented within the time interval.

23. A method for consuming content, comprising:
decoding, with a decoder, a streaming of the content, wherein the stream of content includes a plurality of interleaved segments of primary content sand secondary content, and wherein the secondary content has at least one associated policy that governs response to a user command to skip secondary content during presentation;
receiving, with a user interface engine, user commands, including one or more commands to skip secondary content during presentation; and
presenting the content as the content is decoded from the stream, with a presentation engine, in response to received user commands, wherein presentation of the secondary content in response to a user command to skip secondary content during presentation is in accordance with the at least one associated policy.

24. The method of claim 23, wherein
the at least one associated policy comprises a policy of presenting at least t seconds of each second content disposed in between two segments of primary content, wherein the method further comprises responding to a user command to skip the secondary content during presentation with not playing an entirety of each second content disposed in between two segments of primary content, but playing at least t seconds; or
the at least one associated policy comprises a policy of partially or fully play at least n secondary contents of each group of secondary content disposed between two segments of primary content before skipping to a beginning of the next segment of primary content; wherein the method further comprises responding to a user command to skip the secondary content during presentation, partially or fully playing at least n secondary contents of each group of secondary content disposed between two segments of primary content, then skipping to a beginning of the next segment of primary content.

25. The method of claim 23, wherein
the at least one associated policy comprises a policy of limiting a number of secondary content fully or partially skips, wherein the method further comprises responding to a user command to skip the secondary content during presentation with not playing art entirety or partially of a second content only while the limiting number of secondary content that can be entirely or partially skipped has not been reached; or
the at least one associated policy comprises a policy of skipping any secondary content that has been last presented less than a time interval; wherein the method further comprises responding to a user command to skip secondary content during presentation, skipping any secondary content that has been last presented within the time interval.
